(19) United States
(12) Patent Application Publication
(10) Pub. No.: US 2023/0198266 A1
(43) Pub. Date: Jun. 22, 2023

(54) Installation and Method For Supplying Power To A Subordinate Network Area

(71) Applicants: BKW Energie AG, Bern (CH); Jost AG, Maschinenfabrik, Langnau im Emmental (CH)

(72) Inventors: Patrick Bay, Muensingen (CH); Adrian BACHMANN, Heimisbach (CH)

(73) Assignees: BKW Energie AG, Bern (CH); Jost AG, Maschinenfabrik, Langnau im Emmental (CH)

(21) Appl. No.: 18/084,609

(22) Filed: Dec. 20, 2022

(30) Foreign Application Priority Data
Dec. 20, 2021 (CH) CH 70 750/2021

(51) Int. Cl. H02J 3/38; H02J 3/46; H02J 3/32

(52) U.S. Cl. CPC H02J 3/381; H02J 3/46; H02J 3/32

(57) ABSTRACT

An installation for the supply of electricity to a subordinate network area is disclosed having a first connection to a superordinate network area which can be selectively established and disconnected by a disconnecting switch, a second connection to the subordinate network area, a high-voltage storage battery with charging electronics, a first conditioning device with an inverter for conditioning electrical energy from the high-voltage storage battery, a high-voltage distributor which is conductively connected to the high-voltage storage battery and the first conditioning device for the exchange of electrical energy, a synchronization controller coupled to a measuring probe in the superordinate network area for receiving measuring signals, and a controller for controlling at least the disconnecting switch, the high-voltage distributor and the first processing device. The first conditioning device can be controlled on the basis of the measurement signals received from the measuring probe.

### CROSS REFERENCE TO RELATED APPLICATIONS

This application is a US national filing based upon and claims the benefit of priority to priority document CH 70750/2021, filed Dec. 20, 2021, the content of which is herein incorporated by reference.

### BACKGROUND OF THE INVENTION

### Field of the Invention

The present disclosure relates to an installation for supplying power to a subordinate network area (backup power system) and a corresponding method.

### Description of the Related Art

In the context of power supply networks, backup power systems are used to temporarily supply network areas, both during planned maintenance or construction work and during emergencies, e.g., outages after storms. They comprise an energy source, often a so-called genset with an internal combustion engine and a power generator operated by it. A deployment of such a backup power system can last a few hours, but in certain cases it can last several days or even weeks.

Often, backup power systems are mobile so that they can be transported to the respective site of operation as required.

The load in typical network areas fluctuates relatively strongly, especially due to short-term inrush currents. Since a backup power system has to cope with this fluctuating load, the gensets of conventional systems had to be designed according to the maximum expected load and sized accordingly. In normal operation, however, in many cases only a comparatively low power was required—which ultimately led to inefficient operation. The operation of the backup power system, in particular of the genset, was also always accompanied by considerable noise emissions.

In recent years, many network areas have been equipped with local generators, e.g., photovoltaic (PV) systems, small wind turbines, biogas or biomass power plants, or small hydropower plants. Up to now, in grid replacement mode, these generators had to be deactivated because conventional backup power systems could not handle temporary overproduction in the supplied network area. This means that local production could not contribute to the reduction of peak loads either.

### BRIEF SUMMARY OF THE INVENTION

The present disclosure addresses certain issues in the state of the art including how to create an installation belonging to the technical field of providing a power supply in and/or for a subordinate network area, which enables efficient and quiet operation.

A solution offered for the aforementioned is an installation for the power supply of a subordinate network area which comprises:

a) a first connection to a superordinate network area, wherein the first connection can be selectively established and disconnected by means of a disconnecting switch;
b) a second connection to the subordinate network area;
c) a high-voltage storage battery with charging electronics;
d) a first conditioning device with an inverter, for conditioning electrical energy from the high-voltage storage battery;
e) a high-voltage distributor, which is conductively connected to the high-voltage storage battery and the first conditioning device for the exchange of electrical energy;
f) a synchronization controller coupled to a measuring probe in the superordinate network area for receiving measuring signals; and
g) a controller for controlling at least the disconnecting switch, the high-voltage distributor, and the first conditioning device.

The first conditioning device can be controlled on the basis of the measurement signals received from the measuring probe in such a way that, without a supply interruption in the subordinate network area and with an active superordinate network area, it is possible to switch over from island operation, in which the first connection is disconnected by means of the disconnecting switch, to integrated operation, in which the first connection is established, with a voltage, a frequency and three phases in the subordinate network area being adapted to the superordinate network area during the switchover, by the first conditioning device (resynchronization).

The high-voltage storage battery (or a group of several high-voltage storage batteries) provides a capacity of at least 20 kWh, in particular at least 50 kWh. In particular, it has a voltage of 380 V or more, in particular 750 V or more. It may be based on Li-ion cells or other suitable cell chemistry.

In addition to the inverter, the first conditioning device may in particular comprise a transformer to transform the battery voltage into mains voltage.

The high-voltage distributor is able to selectively create and disconnect connections between the high-voltage storage battery and the first conditioning device using control signals from the controller. The flow of energy between the high-voltage storage battery and the high-voltage distributor and between the high-voltage distributor and the first conditioning device can be in both directions (bidirectional).

In isolated operation, the power supply in the subordinate network area is ensured by the installation according to the invention.

The switchover from islanded operation to integrated operation can take place via a switched-off state of the installation according to the invention, because the installation is not necessary for proper operation in the subordinate network area after reconnection to the superordinate network area. However, the switched-off state can only prevail for a very short time, so that in fact a switchover from island operation to integrated operation takes place.

In contrast to conventional backup power systems, the hybrid installation according to the invention enables the use of energy provided by producers in the subordinate network area. The high-voltage storage battery can absorb production in excess of current demand in this network area as needed. Accordingly, there is a reduction in the required capacity of the installation's energy storage.

The high-voltage storage battery and the first conditioning device facilitate resynchronization and the handling of rapid load changes by enabling the current parameters to be influenced more quickly and easily than, for example, by a genset with variable motor speed.

Advantageously, in integrated operation, the high-voltage storage battery is selectively chargeable with energy from the superordinate network area, and with energy from the subordinate network area.

If the energy generated in the subordinate network area exceeds the current demand, the surplus can be used to charge the high-voltage storage battery. A high-capacity storage battery is advantageous in that it also allows high charging powers, and thus the installation according to the invention can absorb short-term power peaks well. The energy stored in the high-voltage storage battery is then available for subsequent time windows with a surplus demand in the subordinate network.

It is advantageous that in isolated operation and in integrated operation, energy can be supplied from the high-voltage storage battery as required to support the subordinate network area.

In isolated operation, in the event of a demand surplus the energy demand in the subordinate network area is covered by the high-voltage storage battery. In integrated operation, the device according to the invention contributes to a stabilization of the overall network. It is also useful to release energy from the high-voltage storage battery to the superordinate network area if the state of charge of the storage battery is to be deliberately lowered, e.g., in anticipation of a production surplus in the subordinate network area after the transition to island operation. This situation can occur, for example, if the switchover takes place at a time of day with high PV production output and where the expected energy demand in a period after the switchover is lower than the expected production output.

Preferably, in integrated operation, energy from the high-voltage storage battery can be supplied to the subordinate and/or superordinate network area to reduce the charge level of the high-voltage storage battery. Lowering the charge level is particularly useful if production surpluses are expected in the subordinate network area during island operation. This ensures that these surpluses can be absorbed in terms of both power and energy.

Preferably, a voltage, a frequency and three phases of the installation are adaptable to the superordinate network area for switching from a switched-off operating state or from integrated operation to island operation, after which the connection to the superordinate network area can be disconnected by means of the disconnecting switch.

This enables an uninterrupted transition to island operation, without disturbing the consumers and generators in the subordinate network area.

In preferred embodiments, the installation according to the invention comprises a first control device for controlling generators in the subordinate network area, comprising a first input interface for receiving first input data on power availability, a first output interface for transmitting first control data to the generators, and a first processor for processing the first input data and generating the first control data.

In the simplest case, the generators are deactivated—as is known per se—by increasing the grid frequency. Inverters of photovoltaic systems, for example, must be designed in such a way that they switch off automatically when a certain limit frequency is exceeded. Preferably, however, the first output interface and the first control data enable selective deactivation of individual or all generators in the subordinate network area without having to influence the grid frequency for this purpose.

In preferred embodiments, the installation according to the invention comprises a second control device for controlling loads in the subordinate network area, comprising a second input interface for receiving second input data on power availability, a second output interface for transmitting control data to the loads, and a second processor for processing the second input data and generating the second control data.

In the simplest case, the loads are deactivated by lowering the network frequency. Preferably, however, the second output interface and the second control data enable selective deactivation of individual or all loads in the subordinate network area without having to influence the network frequency for this purpose.

The second control device can be identical to the first control device, but they can also be independent components. The same input data can be used for generating the first control data and the second control data, i.e., the first input data and the second input data are identical, or different input data are used.

Preferably, the first and/or second output interface is arranged to couple power line communication signals into the subordinate network area.

The generators and/or consumers can be specifically controlled, for example, by means of power line communication (PLC) signals. Targeted control is also possible via other channels, e.g., via mobile radio and corresponding interfaces.

Control of the loads is also possible via common ripple control signals. For this purpose, the second output interface can be set up to couple ripple control signals generated by the second processor into the subordinate network. In order to be able to control as many consumers as possible, ripple control signals as well as PLC and/or mobile radio signals can preferably be generated and transmitted. In the case of both PLC and ripple control signals, these are decoupled in isolated operation in the subordinate network area from the corresponding signals in the superordinate network area. In integrated operation, the signals from the superordinate network area can be passed on unchanged to the subordinate network area. However, it can also be advantageous to decouple the signals before switching to isolated operation and to prepare the switchover by controlling the generators and/or loads in the subordinate area accordingly.

The first and/or second input interface can be set up to receive PLC signals from the superordinate network area. On the one hand, this data can—as mentioned—be passed on to the subordinate network area in integrated operation (and possibly also in island operation). However, they can also be used to make predictions about consumption and/or production in the subordinate network area.

Advantageously, the first and/or second input interface is arranged to receive real-time generation and/or consumption data.

This data may refer to the subordinate network area and/or the superordinate network area. In the second case, they are useful if they allow conclusions to be drawn about the current conditions in the subordinate network area. From the real-time generation and/or consumption data, it may be possible to obtain short-term forecasts for power production or power demand in the subordinate network area, which in turn can be used to control the installation according to the invention and/or the consumers in the subordinate network area.

In a preferred embodiment, the installation according to the invention comprises the following modules:

a) a supply module with a fuel tank and the high-voltage storage battery;
b) a control module including the controller and a user interface for the controller; and
c) a first power conditioning module including the first conditioning device.

The modular design allows easy replacement of individual modules. In addition, the installation can be easily adapted to the requirements of a specific application, e.g., by replacing the current supply module with another having a higher or lower capacity. It is also possible to adjust the number of modules used on a case-by-case basis, e.g., by providing two or more supply modules if required by the deployment. The individual modules can, for example, be designed as replaceable units that can be installed in a rack and have power and data interfaces adapted to those of the rack.

The installation according to the invention is arranged in particular on a vehicle. The vehicle may be one with an integrated drive, e.g., a truck, or a trailer, which can be coupled to a towing vehicle. The equipment may be built into the vehicle, attached to it, and/or built on top of it. It can also be distributed among several vehicles, which are coupled to each other for operation, at least in terms of energy and data. The arrangement on one vehicle (or on several vehicles) enables flexible and fast operation.

Alternatively, the installation can be designed, for example, as a unit that can be picked up and set down, which may be picked up by a crane, loaded onto a vehicle and unloaded again at the place of use. In principle, the installation according to the invention can also be used stationary.

With the installation according to the presently disclosed invention, a method for supplying power to a subordinate network area may be carried out, the method comprising the steps of:
a) positioning a mobile backup power system at a site of operation;
b) connecting the backup power system to a superordinate network area;
c) connecting the backup power system to the subordinate network area;
d) provision of a high-voltage storage battery of the backup power system with a predefinable charge level;
e) if necessary, disconnecting a connection between the subordinate network area and the superordinate network area;
f) supplying the subordinate network area in isolated operation with suitably conditioned energy from the high-voltage storage battery;
g) reception of measurement signals from a measurement probe in the superordinate network area;
h) matching a voltage, a frequency and three phases in the subordinate network area to the superordinate network area, based on the received measurement signals; and
i) restoration of a connection between the superordinate network area and the subordinate network area after the matching has been made.

Depending on the application, the connection of the backup system to the superordinate network area can be made when setting up the backup system, while the subordinate network area is still supplied by the superordinate network area. This enables a smooth transition to island operation when disconnecting from the superordinate network area. In exceptional cases, e.g., in the event of a fault that has led to an interruption in the supply between the superordinate network area and the subordinate network area, the connection to the superordinate network area is already disconnected. In these cases, the subordinate network area is not supplied until the backup power supply system is commissioned (black start). In this case, the connection to the superordinate network area can be waited for. It is only necessary in preparation for the transition to regular operation to take place, for example, after the connection between the subordinate and the superordinate network area has been repaired.

Depending on the initial state of charge, the predefinable state of charge of the high-voltage storage battery is achieved by selectively charging or discharging the storage battery. Charging can be done with energy from the superordinate network or the subordinate network (depending on availability). Discharging can be done to the superordinate network area (if it is connected to the installation) or to the subordinate network area. The preparation of the high-voltage storage battery can take place already before the transport of the installation to the place of use, e.g., in a depot.

In a first group of embodiments, the high-voltage storage battery allows the installation to operate without a local fuel-powered device for generating electrical energy (such as, for example, a genset). Whether this is possible depends first on the capacity of the high-voltage storage battery, and second on the size of the subordinate network area, the electricity production in the subordinate network area, and the duration and time of use. For example, if the installation is deployed during the daytime, with predicted high solar irradiation and sufficient PV production in the subordinate network area, the high-voltage storage battery can meet the control demand. Installations without a fuel-powered device, especially without genset, are more compact, require less maintenance, and allow a quiet or even virtually silent operation.

In certain cases, for example, when the system is used for a longer period of time, including nighttime hours, additional energy must be provided locally. In such cases, the installation according to the invention further preferably comprises, according to a second group of embodiments:
j) a fuel-powered device for generating electrical energy and a local fuel storage for the fuel-powered device; and
k) a second conditioning device for conditioning the electrical energy of the fuel-powered device.

In this regard, the first conditioning device is also adapted to condition electrical energy from the second processing device, the high voltage distributor is also conductively connected to the second processing device, and the controller is further adapted to control the fuel-powered device for generating electrical energy.

Between the second conditioning device and the high voltage distributor, the current flow is unidirectional from the conditioning device to the distributor.

Even if a fuel-powered device is required for an operation, the installation according to the invention enables a reduction of the operating hours of the fuel-powered device, thus also of the noise exposure time, not only because of the use of the energy generated in the subordinate network, but also, at least for shorter operations, because the high-voltage storage battery can be precharged before switching to isolated operation. Similarly, selective control of the operation of the fuel-powered equipment is made possible, for example, to avoid having to run a diesel engine during nighttime hours, thus avoiding noise emissions during critical time windows. This is of particular advantage if the installation according to the invention has to be placed in the vicinity of residential buildings.

In addition, with the installation according to the invention, both the supply to the subordinate network area and a back-synchronization to the superordinate network area are possible even if the fuel-powered device for generating electrical energy fails (temporarily), e.g., due to a lack of fuel or due to a technical problem in the drive section. If resynchronization is not possible within the period in which the subordinate network area can be supplied with energy from the high-voltage storage battery, the fuel-powered device can be repaired or replaced, or new fuel can be provided.

The installation may be modular so that the fuel-powered device (and, if applicable, the second conditioning device) may be provided or omitted as needed for an operation. Accordingly, the installation preferably comprises a second power conditioning module comprising the fuel-powered electrical energy generation device and the second conditioning device. The fuel tank may be part of this module or the supply module.

The fuel-powered device for generating electrical energy is in particular a so-called genset, i.e., a combination of an internal combustion engine, e.g., a diesel engine, with a generator. However, it can also be based, for example, on a fuel cell that generates electric power from a suitable fuel such as hydrogen, methanol, butane, or natural gas. The fuel-powered device for generating electrical energy may be a genset, with its drive motor operating at a constant speed.

This enables efficient and low-wear operation of the genset's drive motor. Noise emissions can also be reduced in this way, especially because a sound insulation can be perfectly adapted to the noise generation at the constant (and known) speed. Load changes do not require an adjustment of the speed but are absorbed by the high-voltage storage battery and the downstream components.

In alternative embodiments of the installation, a genset may be provided that is operated at different speeds to suit the operating conditions, but speed adjustment is preferably not done dynamically based on the current load, but in steps to affect the power output depending on the state of charge and energy demand.

The second conditioning device includes, for example, a rectifier if the fuel-powered device generates AC power, such as is the case with a genset. It may further comprise a transformer if the voltage is to be adjusted with respect to the further use of the energy, e.g., charging of the high-voltage storage battery.

In integrated operation of an installation with a fuel-powered device, the high-voltage storage battery can also preferably be selectively charged with energy from the fuel-powered device. Thus, when operating the installation, the high-voltage storage battery is charged as needed using energy from the fuel-powered device for generating electrical energy, particularly when energy from the subordinate and superordinate networks is not available.

The high-voltage storage battery is preferably provided with a target charge level that is determined based on a consumption and/or generation forecast for the subordinate network area.

The consumption and/or generation forecast may be generated using a variety of data, including one or more of the following:

information on consumers and generators in the subordinate network area (e.g. number of households, household sizes, commercial consumers, rated outputs of photovoltaic systems, etc.);

a predetermined time window for the use of the installation according to the invention; and/or

historical metering data for consumption and/or production output in the subordinate network area, for individual consumers or producers, or aggregated for the entire area.

The following criteria can be used to determine the target charge level:

sufficiently high charge level to ensure the required supply power (incl. expected fluctuations);

sufficiently low charge level to allow the high-voltage storage battery to absorb energy during power peaks;

charge level in a specified band to conserve the high-voltage storage battery; and/or

minimize noise generated by the operation of the fuel-powered electrical generation equipment (if available), especially during critical time windows (e.g., at night).

In operating phases in which the charge level of the high-voltage storage battery can be influenced in principle, e.g., if the electrical energy generation equipment can be selectively switched on or off without affecting the supply to the subordinate network area, the (new) target charge level can be redetermined on the basis of updated consumption and/or generation forecasts. This redetermination can be done continuously or at fixed intervals.

Advantageously, the generation forecast is at least partially based on a weather forecast, with generation forecasts for weather-dependent generators being derived from the weather forecast. This is particularly useful when weather-dependent generators (e.g., photovoltaic, wind) are present in the subordinate network area.

### BRIEF DESCRIPTION OF THE SEVERAL VIEWS OF THE DRAWINGS

Further advantageous features and details of the various embodiments of this disclosure will become apparent from the ensuing description of preferred exemplary embodiments and with the aid of the drawings. The features and combinations of features recited below in the description, as well as the features and feature combination shown after that in the drawing description or in the drawings alone, may be used not only in the particular combination recited, but also in other combinations on their own, with departing from the scope of the disclosure.

In the following, the presently disclosed invention is described in detail. The description refers to the accompanying drawings, wherein:

FIG. 1 depicts a schematic block diagram of an installation according to the invention;

FIG. 2 depicts a flow diagram of a process according to the invention;

FIGS. 3A-D depict the energy flow in the installation according to the invention in various operating states; and

FIG. 4 depicts the forecast load profile in the subordinate network area and control information derived from it.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C” then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination thereof.

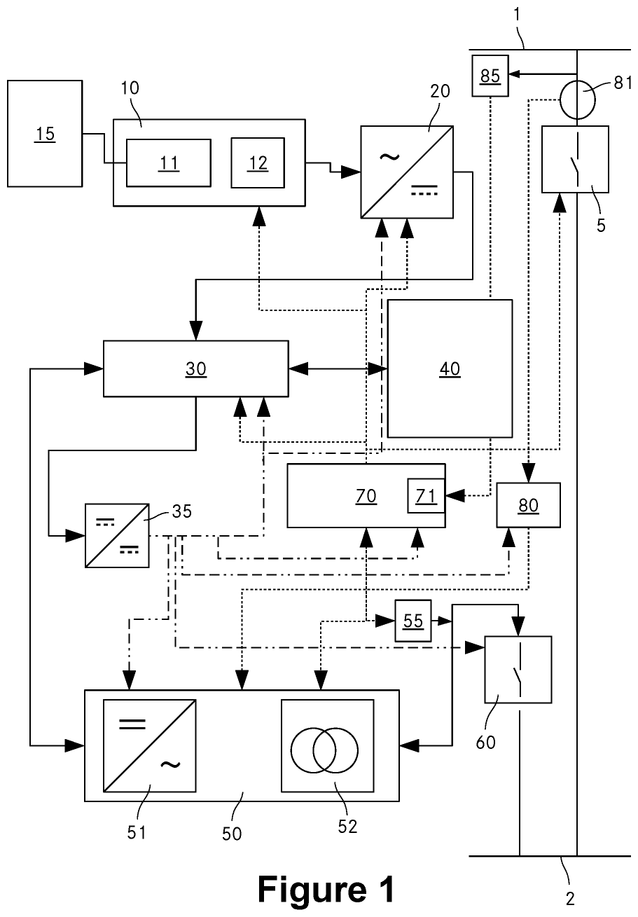

FIG. 1 is a schematic block diagram of a backup power system according to the invention. The installation is mobile and mounted on a vehicle for this purpose. It is connected to a superordinate network area 1 and a subordinate network area 2, wherein the subordinate network area 2 can be disconnected from the superordinate network area by means of a disconnecting switch 5.

The installation includes a genset 10 with a diesel engine 11 that drives a generator 12. The diesel engine 11 is supplied with fuel from a tank 15. In the installation according to the invention, it is operated at a speed adapted to the operating conditions so that a high efficiency can be achieved. In the embodiment, the genset has a continuous power of 40 kW. Alternating current generated by the generator 12 is converted into direct current with a voltage of 750 V by the rectifier 20 connected to the genset 10 and is fed to a high-voltage distributor 30.

Among other things, a high-voltage storage battery 40 is connected to the high-voltage distributor 30. The battery comprises two Li-ion battery modules with a gross capacity of at least 25 kWh each; it can be expanded by further modules if required. The battery voltage is 750 V. The peak charging power of the high-voltage storage battery 40 with two modules is 150 kW, and the continuous charging power is 50 kW. The continuous discharge power (reference power) is 100 kW, and up to 400 kW can be drawn for short periods. The high-voltage storage battery 40 includes charge/discharge electronics.

The high-voltage distributor 30 is further connected to a conditioning device 50. This in turn comprises an inverter 51 and a transformer 52 and enables the 750 V direct current to be converted into three-phase alternating current at a voltage of 400 V. Its rated power is 200 kW. Other components, such as switches and filters, are also part of the conditioning device 50. The output of the conditioning device 50 is connected to the subordinate network area 2 via a main switch 60.

The installation includes a main controller 70 that controls, among other things, the operation of the disconnecting switch 5, the genset 10, the high-voltage distributor 30, and the conditioning device 50. The lines for control signals are shown dotted in the figures. In addition, the installation comprises a synchronization control 80, which is connected to a measuring probe 81 in the superordinate network area, i.e., upstream of the disconnecting switch 5, and which transmits processed measuring signals to the conditioning device 50.

Further, the installation includes a first PLC interface 85 that is connected to the superordinate network area 1 for receiving power line signals. The signals are transmitted to an input interface 71 of the main controller 70, which processes them with other signals received via the input interface 71 to generate control signals. The control signals are coupled into the subordinate network area 2 via a second PLC interface 55.

The main controller 70 and the synchronization control 80 as well as, among others, the rectifier 20, the high-voltage distributor 30, the conditioning device 50 and the main switch 60 are supplied by a converter 35, which is connected to the high-voltage distributor 30 and provides an operating voltage of 24 V DC (continuous power 4,000 W) for the components mentioned. The lines for the low-voltage electrical supply are shown in dash-dotted lines in the figures.

Not shown in FIG. 1 is the thermal management. Cooling and heating devices known per se, controlled by the main controller 70, provide cooling for the genset 10, the conditioning device 50 and, if necessary, other components such as the converter 35, as well as temperature control (cooling or heating) for the high-voltage storage battery 40. The latter ensures that the battery can operate in the optimum temperature range under a wide variety of environmental conditions, such as those that can occur in mobile use.

The body on the vehicle is divided into four modules:
I. a supply module with the tank 15 and the high-voltage storage battery 40;
II. a first power conditioning module with the conditioning device 50;
III. a second power conditioning module comprising the genset 10 and the rectifier 20; and
IV. a control module comprising, inter alia, the main controller 70 and a corresponding user interface.

Overall, the installation described here enables the subordinate network area 2 to be supplied with a peak power of 200 kW (from the high-voltage storage battery 40 with subsequent conditioning), a continuous power over 15 min of 100 kW (purely electric) and a hybrid continuous power over at least 30 min of 95 kW. By adapting the high-voltage storage battery accordingly (e.g., by adding further battery modules) and/or the genset, the performance data can be adapted to the intended application.

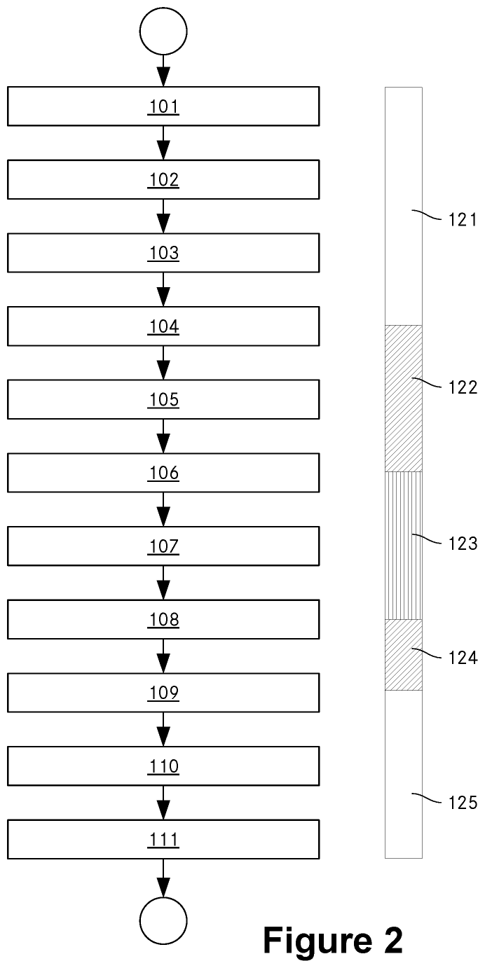

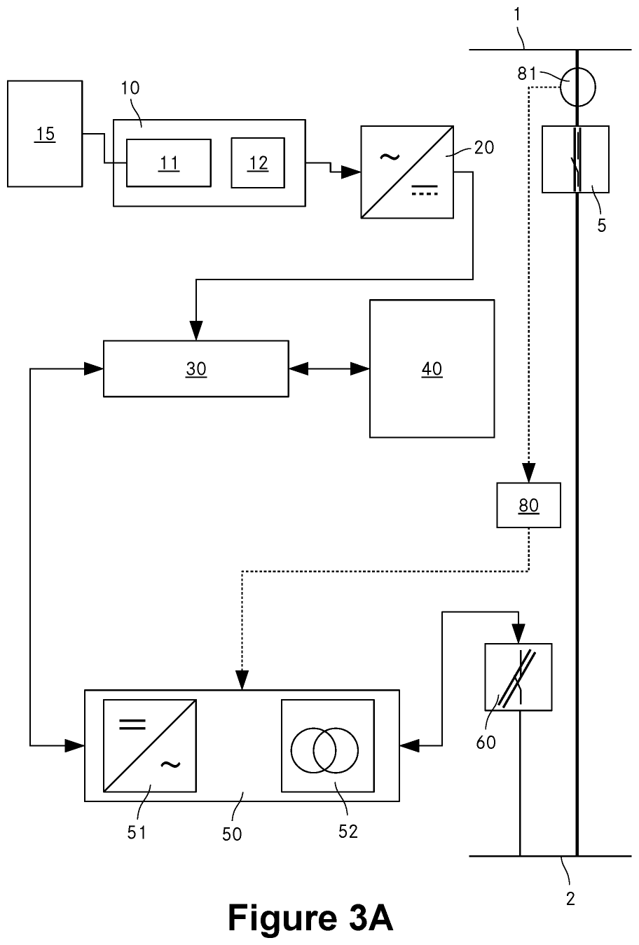

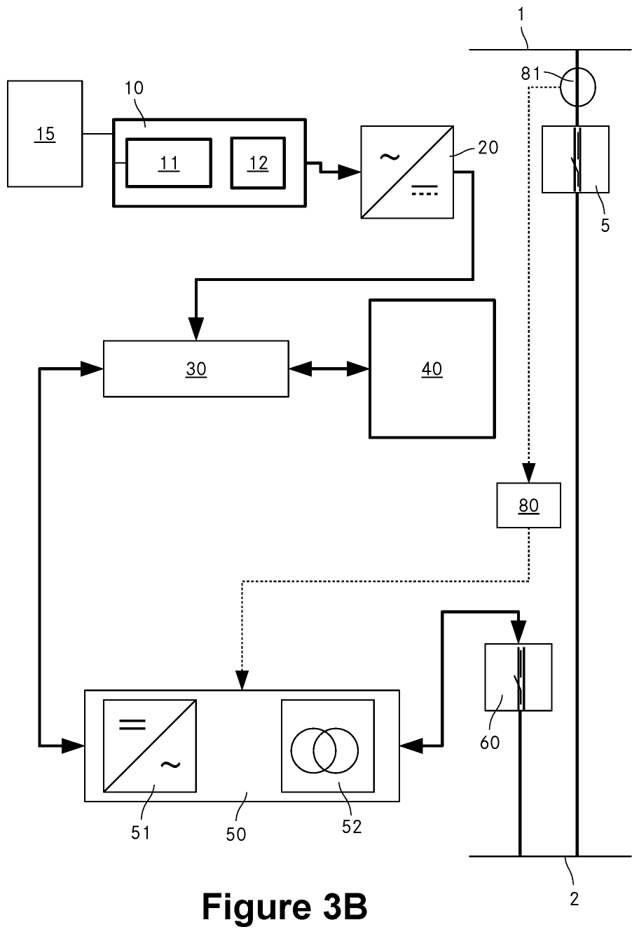

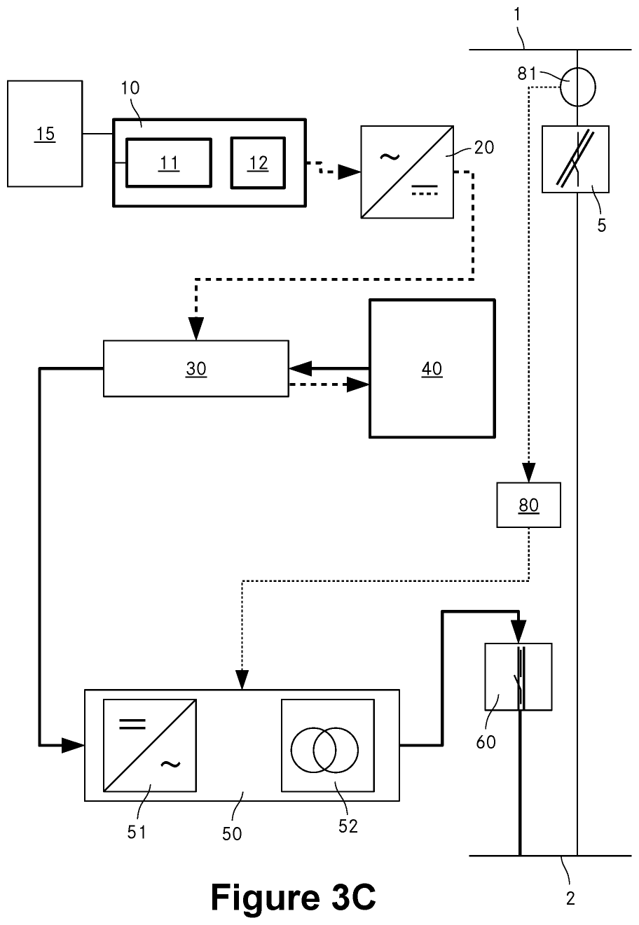

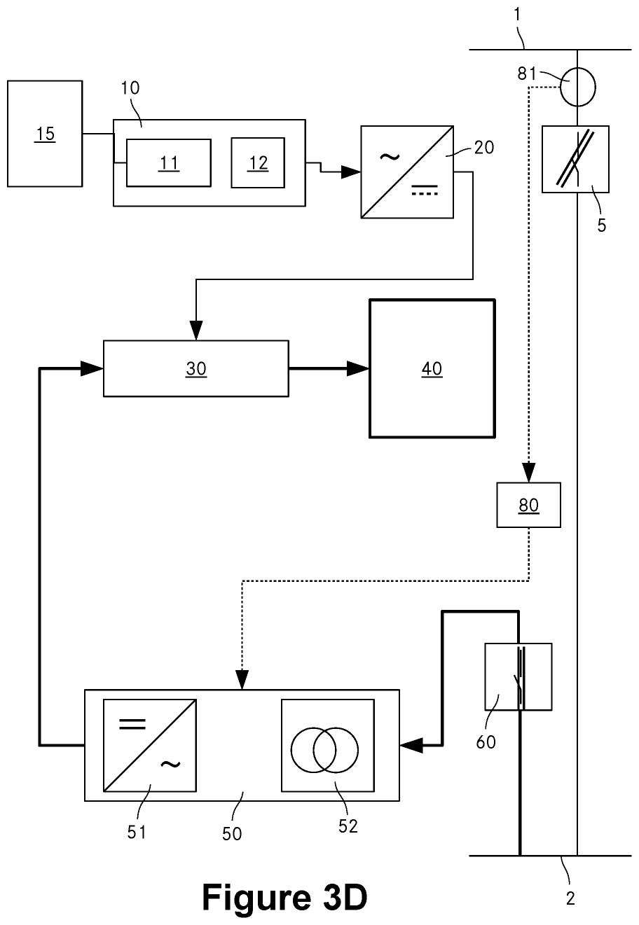

FIG. 2 is a flow diagram of a process according to the invention, FIGS. 3A-D schematically represent the energy flow in the installation according to the invention in different operating states.

In the following, it is assumed that, due to planned maintenance work, the supply of a subordinate network area is to be taken over for a few hours by the backup power system according to the invention. For this purpose, the installation is first positioned at the site of operation (step 101), connected to the superordinate network (step 102) and connected to the subordinate network (step 103). Until then, it is in the switched-off operating state 121, which is shown in FIG. 3A. The subordinate network area 2 is supplied directly from the superordinate network area 1. The disconnecting switch 5 is closed, the main switch 60 is open.

Now the installation can be switched on (step 104). In particular, the main switch 60 is also closed and the installation switches to the integrated operating state 122 (P/Q operation), which is shown in FIG. 3B. The subordinate network area 2 continues to be supplied by the superordinate network area 1, the installation according to the invention is synchronized with the network areas in terms of frequency, voltage and phases and can, for its part, feed energy into the connected network areas or draw energy from them, in particular for the targeted charging or discharging of the high-voltage storage battery 40. In this operating state, charging of the high-voltage storage battery 40 is alternatively or additionally also possible with the aid of the genset 10. With regard to the upcoming island operation, the high-voltage storage battery 40 is now preconditioned (step 105), i.e., charged or discharged to a predefined state of charge and tempered to the best possible temperature.

Subsequently, immediately before starting work on the network, the subordinate network area 2 is disconnected from the superordinate network area 1 together with the backup power system by opening the disconnecting switch 5 (step 106). The installation switches to isolated operation (operating state 123). The supply of the subordinate network area 2 is completely ensured by the backup power system. In the event of excess demand, this is covered with electrical energy from the high-voltage storage battery 40 (cf. FIG. 3C). For this purpose, the genset 10 is activated as required to recharge the high-voltage storage battery. In the event of a power surplus in the subordinate network area, e.g., in the event of a high PV output with simultaneously low energy demand, the surplus energy from the subordinate network area 2 is stored in the high-voltage storage battery 40 (cf. FIG. 3D).

In the exceptional event instantaneous demand cannot be met, the installation may provide means to disconnect loads in subordinate network area 2, such as one or more of the following:
transmission of a ripple control signal to the subordinate network area 2;
transmission of shutdown signals (or power reduction signals) to corresponding receivers of the facilities to be shut down (e.g. by means of power line signals via the PLC interface 55 and/or via mobile radio connections) or control stations in the subordinate network area 2 (e.g. facilities of the public sector, for street lighting or similar); and/or
reduction of the network frequency in the subordinate area to trigger a frequency-dependent load shedding.

In the exceptional event, that momentary overproduction cannot be taken by the installation, the installation may provide means to disconnect generators in subordinate network area 2, such as one or more of the following:
transmission of shutdown signals (or power reduction signals) to corresponding receivers of the equipment to be shut down (e.g., by means of power line signals via the PLC interface 55 and/or via mobile radio links); and/or
increasing of the grid frequency in the subordinate area to reduce the production power or shut down generators.

After completion of the maintenance work and when the superordinate network area 1 is active again at the respective connection point, the installation is resynchronized with the superordinate network area 1 with a view to reconnecting the subordinate network area 2 with the superordinate network area 1 (step 107). For this purpose, the measuring probe 81 detects the voltage, frequency, and phases in the superordinate network area 1, and the synchronization control 80 passes the corresponding information to the conditioning device 50. The latter then adjusts the voltage, frequency, and phases to those in the superordinate network area 1 by controlling the inverter 51 accordingly, so that the superordinate network area 1 and the subordinate network area 2 run synchronously even though they are not connected to each other.

As soon as this synchronicity is achieved, the network areas can be reconnected to each other by closing the disconnecting switch 5 (step 108). The installation then returns to integrated operation (operating state 124). It can then be switched off (step 109, operating state 125 “off”), disconnected from the superordinate network area 1 and from the subordinate network area 2 (step 110) and finally transported away again (step 111).

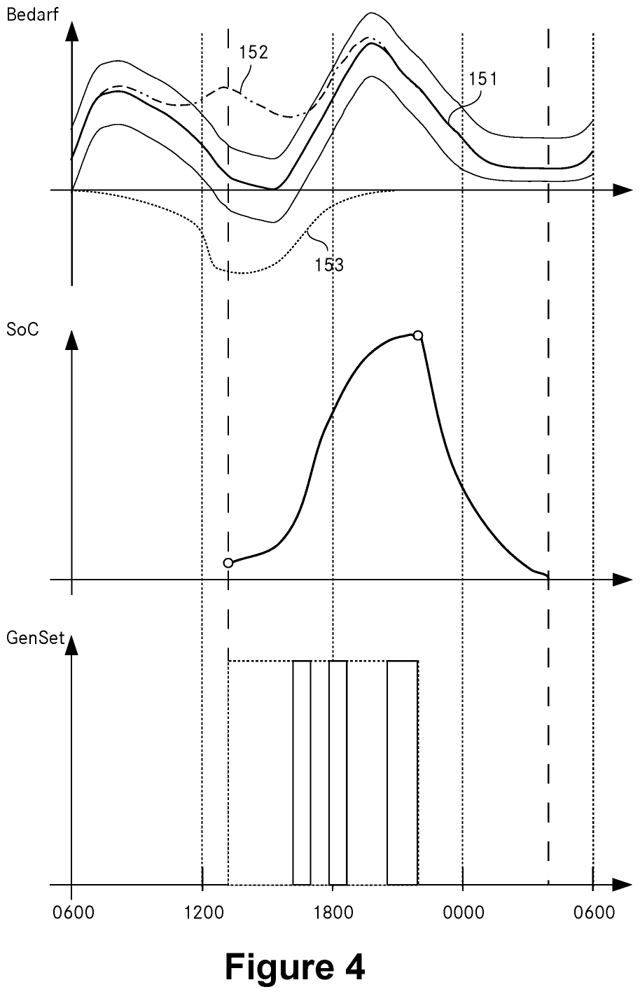

FIG. 4 depicts the forecasted load profile in the subordinate network area and control information derived from it, during 24 hours, e.g., from 06.00 hrs. to 06.00 hrs. of the following day. Load profile 151 is the difference between energy demand 152 and energy generation 153 in the subordinate network area. For dispatch planning, some uncertainty in the load profile 151 (thin solid lines) is taken into account.

The forecast of the energy demand 152 is generated from historical information, wherein, in addition to the structure of the subordinate network area, the season and the day of the week, short-term factors relevant to consumption, such as the forecast outside temperature, can also be taken into account. The historical data can relate specifically to the subordinate network area and/or be calculated from general data taking into account local conditions.

On the one hand, the power generation forecast is also based on historical data. On the other hand, however, weather forecast data is used to forecast the output of weather-dependent generators, especially PV and wind power plants, in the subordinate network area. In the example shown, the subordinate network area has several PV production plants. Initially, cloudy skies are forecast for the morning, so reduced PV production is assumed. From midday onwards, sunny weather is then forecast, so that maximum PV production is assumed in the afternoon, as can be expected on the respective day in the year.

Set points for conditioning and controlling the installation are derived from the predicted load profile 151. For example, a relatively low set point for the state of charge (SoC) of the high-voltage storage battery is specified for 13.00 hrs., the start time of islanding operation, so that possible energy surpluses in the subordinate network area can be absorbed. If there is a demand surplus during this period, the installation can easily run in hybrid operation, and the genset is activated accordingly as a matter of principle—wherein an activation is of course only made if it is necessary for the supply of the subordinate network.

A high set point value for the state of charge is specified for 22.00 hrs. This is achieved by operating the genset appropriately in the time window between 13.00 hrs. and 22.00 hrs. and is intended to ensure that the night-time supply is provided from the high-voltage storage battery as far as possible. This minimizes noise emissions from the installation. Activation of the genset in the period from 22.00 hrs. to the planned end of island operation at 04.00 hrs. will only occur if this is necessary to supply the subordinate network area.

For longer operating periods, it may be necessary to raise and/or lower the state of charge of the high-voltage storage battery several times. This is also achieved by controlling the operation of the genset accordingly.

During operation of the plant, the forecasts and target values derived from them can be automatically adjusted on an ongoing basis, e.g., when updated weather data are available or when, for example, real-time information on energy use and/or generation is available. For example, consumption forecasts can be generated from traffic data because increased traffic volume indicates that—with a certain time delay—increased energy demand for charging battery electric vehicles is to be expected. Larger consumers, such as businesses or public charging stations, in the subordinate network area can provide further information that can be used to update the installation's operational planning.

The invention is not limited to the embodiment shown. In particular, the components of the installation used and their operating data may differ from those of the installation described. The same applies to their specific interaction. Preconditioning of the high-voltage storage battery may already take place before transport to the site of operation, e.g., in a depot. In certain cases, especially in the case of unplanned operations (emergencies), the power supply in the subordinate network area is only restored by connecting and switching on the backup power system; accordingly, a somewhat different process sequence results.

As explained above, an installation according to the invention can also be operated without a genset. Accordingly, the fuel tank, the genset and the downstream rectifier are missing in such installations, or they are provided in modular form and are carried along and connected depending on the operation. If the installation is operated without a genset or is not equipped with one, surplus demand in isolated operation is always covered by electrical energy from the high-voltage storage battery. This must be taken into account when dimensioning the battery, determining the initial setpoint of the state of charge and controlling the loads in the subordinate network area.

In summary, the invention creates an installation for supplying power to a subordinate network area that provides efficient and quiet operation.

Some advantageous embodiments of the device according to the invention have been described above. The invention is however not limited to the embodiments described above, but the inventive idea can be applied in numerous ways within the scope of the claims.

What is claimed is:

1. An installation for the supply of electricity to a subordinate network area, the installation comprising:
a first connection to a superordinate network area, the first connection configured to be selectively established and disconnected by a disconnecting switch;
a second connection to the subordinate network area;
a high-voltage storage battery with charging electronics;
a first conditioning device with an inverter, the first conditioning device configured to condition electrical energy from the high-voltage storage battery;
a high-voltage distributor arranged conductively connected to the high-voltage storage battery and the first conditioning device and configured to exchange electrical energy;
a synchronization controller coupled to a measuring probe in the superordinate network area for receiving measuring signals;
a controller for controlling at least the disconnecting switch, the high-voltage distributor, and the first conditioning device; and
wherein the first conditioning device is configured to be controlled on the basis of the measurement signals received from the measuring probe such that, without an interruption of supply in the subordinate network area and with an active superordinate network area, a switch over from an isolated operation, in which the first connection is disconnected by means of the disconnecting switch, to an integrated operation, in which the first connection is established, wherein, during the switchover, a voltage, a frequency and three phases in the subordinate network area are adapted to the superordinate network area by the first conditioning device is enabled.

2. The installation according to claim 1, wherein, in integrated operation, the high-voltage storage battery is configured to be selectively chargeable with energy from at least one of the fuel-powered device, the superordinate network area, and the subordinate network area.

3. The installation according to claim 1, wherein in isolated operation and in integrated operation, energy can be delivered from the high-voltage storage battery as required to support the subordinate network area.

4. The installation according to claim 1, wherein, in integrated operation, the high-voltage battery is configured to deliver energy to the subordinate and/or superordinate network area so as to lower a charge level of the high-voltage storage battery.

5. The installation according to claim 1, wherein, for switching from a switched-off operating state or from integrated operation to isolated operation, a voltage, a frequency and three phases of the installation are adaptable to the superordinate network area, after which the connection to the superordinate network area can be disconnected by means of the disconnecting switch.

6. The installation according to claim 1, comprising a first control device configured to control generators in the subordinate network area, the first control device comprising a first input interface configured to receive first input data on power availability, a first output interface configured to transmit first control data to the generators, and a first processor configured to process the first input data and generating the first control data.

7. The installation according to claim 1, comprising a second control device configured to control loads in the subordinate network area, the second control device comprising a second input interface configured to receive second input data on power availability, a second output interface configured to transmit control data to the loads, and a second processor configured to process the second input data and generating the second control data.

8. The installation according to claim 6, wherein the first output interface is arranged so as to couple power line communication signals into the subordinate network area.

9. The installation according to claim 6, wherein the first input interface is arranged so as to receive at least one of real-time generation and consumption data.

10. The installation according to claim 1, further comprising:
a fuel-powered device configured to generate electrical energy and a local fuel storage facility for the fuel-powered device; and
a second conditioning device configured to condition the electrical energy of the fuel-powered device; and
wherein the first conditioning device is configured to condition electrical energy from the second conditioning device;
the high-voltage distributor is arranged conductively connected to the second conditioning device; and
the controller is configured to control the fuel-powered device for generating electrical energy.

11. The installation according to claim 10, wherein, in integrated operation, the high-voltage storage battery is configured to be selectively chargeable with energy from the fuel-powered device.

12. The installation according to claim 1, comprising:
a supply module comprising the high-voltage storage battery;
a control module comprising the controller and a controller user interface; and
a first power conditioning module comprising the first conditioning device.

13. The installation according to claim 10, further comprising:
a supply module comprising the high-voltage storage battery;
a control module comprising the controller and a controller user interface;
a first power conditioning module comprising the first conditioning device; and
a second power conditioning module comprising the fuel-powered device configured to generate electrical energy, the second conditioning device and wherein the supply module comprises a fuel tank.

14. A method for supplying power to a subordinate network area, the method comprising the steps of:
positioning a mobile backup power system at a site of operation;
connecting the backup power system to a superordinate network area;
connecting the backup power system to the subordinate network area;
providing a high-voltage storage battery of the backup power system, the high-voltage storage battery comprising a predefinable charge level;
optionally disconnecting a connection between the subordinate network area and the superordinate network area;
supplying the subordinate network area in isolated operation with suitably conditioned energy from the high-voltage storage battery;
receiving measurement signals from a measurement probe in the superordinate network area;
matching a voltage, a frequency and three phases in the subordinate network area to the superordinate network area, the matching based on the received measurement signals; and
restoring a connection between the superordinate network area and the subordinate network area after the matching has been made.

15. The method according to claim 14, further comprising the steps of optionally charging the high-voltage storage battery by means of energy from a fuel-powered device configured to generate electrical energy.

16. The method according to claim 15, wherein the fuel-powered device is a genset comprising a drive motor configured to be operated at a constant speed.

17. The method according to claim 14, wherein the high-voltage storage battery comprises a target charge level based on at least one of a consumption forecast for the subordinate network area and a generation forecast for the subordinate network area.

18. The method according to claim 17, wherein:
the generation forecast is based at least in part on a weather forecast, and
the generation forecasts for weather-dependent generators are derived from the weather forecast.

19. The installation according to claim 7, wherein the second output interface is arranged to couple power line communication signals into the subordinate network area.

20. The installation according to claim 7, wherein the second input interface is arranged to receive at least one of real-time generation and consumption data.
